(19) United States
(12) Patent Application Publication
(10) Pub. No.: US 2010/0139712 A1
(43) Pub. Date: Jun. 10, 2010

(54) Dosing System For A Concentrated Laundry Composition

(75) Inventors: Feng-Lung Gordon Hsu, Tenafly, NJ (US); Sudhakar Puvvada, Upton (GB); Mei Shi, Ridgewood, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The Sun Products Corporation, Wilton, CT (US)

(21) Appl. No.: 12/706,424

(22) Filed: Feb. 16, 2010

Related U.S. Application Data
(62) Division of application No. 11/147,965, filed on Jun. 8, 2005.

(51) Int. Cl. B08B 3/02

(52) U.S. Cl. 134/36

(57) ABSTRACT

A laundry detergent system comprising a highly concentrated liquid laundry detergent and a device connected to a water supply feed, that provides the injection pressure of the detergent composition being greater than water flow pressure at the junction of the detergent composition and the water flow and water flow rate at the junction of greater than 0.25 m/sec; wherein the flow rate ratio of the detergent composition to the water flow is in the range of from about 0.0001 to about 0.5.

### CROSS-REFERENCE TO RELATED APPLICATIONS

This application is a Division of U.S. application Ser. No. 11/147,965, filed Jun. 8, 2005, the entire disclosure of which is incorporated herein by reference.

### BACKGROUND OF THE INVENTION

1. Field of the Invention

Laundry detergent system for dispensing a concentrated laundry detergent composition into an automatic laundry washing machine, and methods for use thereof.

2. Background Art

Highly concentrated liquid detergent compositions (HCLD), with surfactant concentration range between 50% to 100%, are not readily available in the consumer market due to their difficulty in dispensing, and/or dispersion and/or dissolution in the wash. One of the major problems is the HCLD's tendency to gel upon contact with water. HCLDs, however, are advantageous in many ways. One advantage is lowering the packaging cost. Another benefit is the decrease in shipping cost due to the reduction of non-functional components such as water. Also, stability of such compositions is improved—the minimal amount of water in the detergent composition does not provide ground for growth of microorganisms, thus reducing or even eliminating the use of preservatives. Also, due to the low amount of water, stability of water-sensitive ingredients, such as enzymes, is improved, removing the need for non-functional stabilizers.

Various devices for delivering ingredients in a controllable way to washing machines have been described. See, for instance U.S. Pat. No. 4,981,024, U.S. Pat. No. 3,982,666, U.S. Pat. No. 3,881,328, U.S. Pat. No. 4,103,520, U.S. Pat. No. 4,932,227, EP 0611,159, U.S. Pat. No. 5,207,080, US 2003/0116177, U.S. Pat. No. 4,103,520, EP 1088927, WO 03/033804, US 2004/088796, WO 03/069043, US 2003/0182732, and GB 2 134 078.

If a method or device can be developed in preventing the gelling of the HCLD and helping the dispersion and dissolution of such compositions in the wash, then consumers can receive a range of benefits including a smaller and lighter detergent package, and lower costs without compromising the quality of the product.

The present invention is based at least in part on the discovery that by dispensing HCLD with a fast-moving or high shear water flow, the phenomenon of HCLD forming a gel in water, which contributed to the difficulty of dispersion and dissolution in water, is eliminated. By combining HLCD with the appropriate dispensing method, HCLD use by the consumers can be rendered commercially feasible.

### SUMMARY OF THE INVENTION

The present invention includes, in its first embodiment, a laundry detergent system comprising:

(a) a highly concentrated liquid laundry detergent composition comprising:
(a1) a surfactant, selected from anionic, nonionic, cationic surfactants and mixtures thereof in an amount of from about 50% to about 100%, by weight of the composition; and
(a2) a solvent in an amount of from about 0% to about 10%; and

(b) a device connected to a water supply feed, that provides the injection pressure of the detergent composition being greater than water flow pressure at the junction of the detergent composition and the water flow and water flow rate at the junction of greater than 0.25 m/sec;

(c) wherein the flow rate ratio of the detergent composition to the water flow is in the range of from about 0.0001 to about 0.5.

The inventive system is suitable for residential washing machines, as well as industrial, or commercial washing machines. The inventive device is suitable for use with front-loading or top-loading washing machines.

The following detailed description and the drawings illustrate some of the effects of the inventive compositions. The invention and the claims, however, are not limited to the following description and drawings.

### BRIEF DESCRIPTION OF THE DRAWINGS

FIG. 1 is a schematic drawing of the preferred embodiment of the invention, employing a reducer.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.”

It should be noted that in specifying any range of time or physical conditions, any particular upper limit can be associated with any particular lower limit.

For the avoidance of doubt the word “comprising” is intended to mean “including” but not necessarily “consisting of” or “composed of.” In other words, the listed steps or options or components need not be exhaustive.

“Liquid” as used herein means that a continuous phase or predominant part of the composition is liquid and that a composition is flowable at 20.degree. C. Solids (e.g., suspended or other) may be included. Gels and pastes are included within the liquids as used herein.

“Reducer” as used herein means a device or a fitting with a constricted cross-area at the end of the axial flow direction. Flow fluid passing through the tube speeds up as it enters the tube's constricted section, results in the generation of high shear and a vacuum, which causes the dosing of a laundry care composition from a laundry care container to the washing machine. It is highly desirable to have a gradual reduction of diameter to reduce the pressure loss.

“Venturi tube” as used herein means a pipe with a constricted inner cross-area (throat); fluid passing through the tube speeds up as it enters the tube's throat, and the pressure drops generating a vacuum, which causes the dosing of a laundry care composition from a laundry care container to the washing machine. In some sense, a Venturi tube is a combination of a reducer and an enlargement, which has the same structure as a reducer but also includes the flow from constricted region to non-constricted region.

“Along water supply feed” means that the device is connected to the washing machine via incoming and outgoing water supply hoses, into and out of the device, the outgoing water supply hoses then leading to the washing machine.

### Highly Concentrated Liquid Detegent (HCLD) Compositions

Composition suitable for use in the present inventions comprise from 50% to 100% surfactant, preferably from 60 to 100% of a surfactant, preferably above 65%, and most preferably higher than 75%. Suitable surfactants are selected from the group consisting of anionic, nonionic, cationic, zwitterionic surfactants and mixtures thereof.

The solvent level is less than or equal to 10%, preferably less than 6%, and most preferably less than 4%. The solvents are selected from ethanol, propanol, propyleneglycol, polypropyleneglycol, glycerin, and other water-soluble organic solvents. Other components in the HCLD may include enzyme, fluorescent dye, builder, buffering agent, anti-redeposition agent, soil release polymer, dye, fragrance, bleach system and other minor ingredients.

The water level is less than or equal to 30%, preferably less than 20%, and most preferably less than 10%. The viscosity of HCLD at 21 l/sec shear rate is less than 5,000 mPas preferably less than 3,000 mPas and most preferably less than 1,000 mPas.

The wash dosage is less than 150 g, preferably less than 100 g, more preferably less than 50 g, and most preferably less than 25 g.

The method of dispensing the HCLD is introducing the HCLD into a high velocity water stream. The axial velocity at the junction of HCLD and water flow is greater than 0.25 m/sec, preferably greater than 0.5 m/sec, and most preferably greater than 1 m/sec. In general, the velocity should be less than 10 m/sec to reduce the need for unnecessarily high water pressure.

In general, the required water pressure to produce such velocity is greater than 3.4 N/cm², preferably greater than 10.² N/cm², most preferably greater than 23.8 N/cm². The HCLD may be introduced to the high velocity of water simply by gravitational force, or via a selection from a pump, a pressurized HCLD reservoir or a reducer which generates vacuum force by speeding up the water speed at the smaller diameter section of the reducer. The pressure of HCLD flow has to be greater than the water pressure at the junction.

The flow rate ratio of the HCLD to the water flow is in the range of from 0.0001 to 0.5, preferably from 0.001 to 0.2, most preferably from 0.005 to 0.1, in order to ensure the dispersion and dissolution of HCLD.

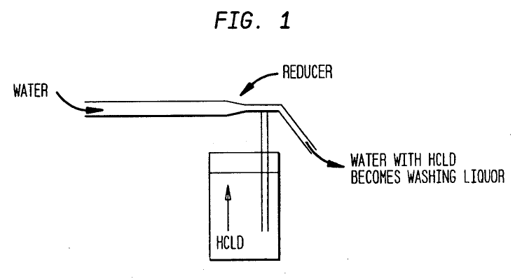

For a low water pressure area, a pump may be needed to provide the required water pressure. The device with pump is highly preferred for washing machines, which are placed at a low water pressure locations. Otherwise, according to the present invention, the reducer mechanism is preferred (as demonstrated in FIG. 1), since it has no moving parts, as in the pump. In addition, the reducer-based device does not require a power supply.

Turning now to FIG. 1, a junction of HCLD flow and water flow is at the constricted section of a reducer. The reducer is installed along the water supply feed, i.e. a water supply hose. As the water passes through the constricted region of the reducer, where the water flow velocity increases and the HCLD is gradually drawn into the water flow path due to the vacuum. Not to be bound by the theory, the inventors believe the results can be contributed by two factors. One, the fast flow of water disperses surfactant molecules before its fully hydration and alignment to each other that the surfactant molecules become structured and form gel in water. Second, the fast water flow has enough kinetic force to destroy any structure that may be formed by the surfactant molecules.

The number of the reducers within the device is generally the same as the number of water supply hoses. With a single water supply hose, the inventive device with a single reducer is employed, as shown in FIG. 1.

The diameters of the entrance region, De, and the constricted region, Dc, of the reducer play an important factor in the efficiency of the method. The reduction of the diameter at the constricted region of a reducer converts the water pressure, a potential energy, to the kinetic energy and speeding up the water flow velocity. As the De/Dc ratio increases, the velocity of the water in the constricted region increases, thus kinetic energy increases, which better helps to destroy any structure formed by the surfactant molecules in washing liquor. According to the preferred embodiment of the invention, the ratio of De/Dc is greater than 1.65, most preferably greater than 2.5, in order to attain the required vacuum for dosing the products. If the internal diameter of water hoses is less than the entrance diameter of the end of the reducer (De), then the preferred ratio should be based on the ratio of the internal diameter of water hose to the diameter of the throat of the reducer (Dc).

The inventive system may be further connected to another system of a reducer and a laundry booster composition, which is an aqueous product containing ingredients selected from surfactant, enzyme, fluorescent dye, builder, buffering agent, anti-redeposition agent, soil release polymer, dye, fragrance, and bleach system or mixtures thereof. It is preferred to dose the booster and HCLD sequentially. Buffer and builder are preferably dosed prior to the dosing of HCLD and the bleach system is preferably dosed after the dosing of HCLD. The reducer/composition systems may be daisy chained together.

### Intermediate Dosing Chamber

In another embodiment of the present invention, an intermediate chamber is added along the passage connecting the laundry care dosing container and the reducer or the pump to provide a better control for a user. A check valve is located between the chamber and the reducer or the pump. The other end of the chamber is connected to a product container with a built-in on/off valve, which is used to control the flow of product from the laundry care product container to the intermediate chamber. An o-ring, as a seal, is located the intake stem above the on-off valve. The see-through chamber has various dosage lines for different dosage.

The intermediate dosing chamber is pre-filled by opening the on-off valve between the product container and the intermediate chamber. The on/off valve is manually controlled. Alternatively, the manual on-off valve can be also replaced with a solenoid valve, which is controlled by the algorithm to open the solenoid valve at various times for various dosages according to the combination of the selection of load size and the degree of dirt in the wash load.

### EXAMPLE 1 AND COMPARATIVE EXAMPLE A

The composition of Example 1 (within the scope of present invention) was prepared by first forming two premixes. Typically, premix I was prepared by first mixing LAS and Neodol®25-7 to form a clear solution, and later adding NaOH to reached complete neutralisation. Finally, TEA was added to Premix I as a buffering agent. Premix II was prepared by mixing florescent dye with water and Neodol® 25-7 until complete dissolution was reached. The two premixes were then mixed together, forming the main mix, where sodium LES, ethanol, propyleneglycol and enzyme were finally added and blended in to reach homogenous mixture, which was a flowable liquid at room temperature. The composition for Example 1 is summarised in Table 1.

TABLE 1

| | wt % |
|---|---|
| Premix I | |
| Neodol ® 25-7 | 25.75 |
| LAS acid | 26.46 |
| NaOH | 6.79 |
| Triethanolamine | 1.29 |
| Premix II | |
| water | 1.29 |
| Whiting agent | 0.32 |
| Neodol ® 25-7 | 12.87 |
| Sodium LES | 18.41 |
| ethanol | 1.29 |
| propylene glycol | 3.99 |
| Misc. | To 100 |
| Total surfactant, % | 78.95 |
| Q_{d}/Qₚ* | 0.001 |
| Velocity**, m/sec | 1.5 |

*Q_{d}/Qₚ is the flow rate ratio of the detergent composition to the flow rate.
**Axial velocity at the constricted region of the reducer.

The device, which is a reducer with De/Dc ratio of 2, was connected to a tap water faucet. When the water was turned on, 3 gram of HCLD of the composition detailed in Table 1 was sucked, dispersed and dissolved into the washing liquor without forming any gel phase. Totally 3 liters of water and 3 grams of Example 1 were collected in the bucket. The dissolution of the surfactant molecules was immediate and no gel formation was observed.

Comparative Example A was carried out by adding 3 grams of the Example 1 to 3000 gram of water (room temperature), in the absence of the reducer device, and so in the absence of the requisite pressure and flow rate parameters. Because the water was still, the water velocity was 0 m/sec for Comparative example A. Gel immediately formed as the composition came into contact with the water.

What is claimed is:

1. A method of dispensing a highly concentrated liquid laundry detergent composition into a laundry washing machine, comprising:
introducing a highly concentrated liquid laundry detergent composition into a water supply feed at a junction, wherein a flow rate ratio of the detergent composition to the water flow is in the range of from about 0.0001 to about 0.5, and wherein the detergent composition comprises:
a surfactant, selected from anionic, nonionic, cationic surfactants and mixtures thereof in an amount of from about 50% to about 100%, by weight of the composition; and
a solvent in an amount of from about 0% to about 10%, by weight of the composition; and
providing a device connected to the water supply feed, that provides the injection pressure of the detergent composition being greater than the water flow pressure at the junction of the detergent composition and the water flow and provides a water flow rate at the junction of greater than 0.25 m/sec.

2. The method of claim 1 wherein the device comprises a reducer installed along the water supply feed, wherein the junction of the detergent composition and the water flow is at the constricted section of the reducer.

3. The method of claim 2 wherein the ratio of the internal diameters of the entrance and exit of the reducer is greater than 1.65.

4. The method of claim 2 wherein the ratio of the internal diameter of a water supply feed hose to the internal exit diameter of the reducer is greater than 1.65.

5. The method of claim 2 wherein the reducer is a Venturi tube.

6. The method of claim 1 wherein the water content of the composition is less than 30%, by weight of the composition.

7. The method of claim 1 wherein the composition contains functional ingredients selected from the group consisting of enzymes, fluorescent dyes, builders, buffering agents, anti-redeposition agents, soil release polymers, dyes, fragrances, and bleach systems.
